(19) United States
(12) Patent Application Publication
(10) Pub. No.: US 2021/0021739 A1
(43) Pub. Date: Jan. 21, 2021

(54) LENS MODULE

(71) Applicant: TRIPLE WIN TECHNOLOGY(SHENZHEN) CO.LTD., Shenzhen (CN)

(72) Inventors: SHIN-WEN CHEN, Tu-Cheng (TW); JING-WEI LI, Shenzhen (CN); SHENG-JIE DING, Shenzhen (CN); JIAN-CHAO SONG, Shenzhen (CN)

(21) Appl. No.: 16/536,436

(22) Filed: Aug. 9, 2019

(30) Foreign Application Priority Data
Jul. 18, 2019 (CN) 201910651705.2

(51) Int. Cl. H04N 5/225; G02B 7/02; G02B 5/20

(52) U.S. Cl. CPC H04N 5/2253; G02B 7/02; G02B 5/208; H04N 5/2254; H04N 5/2252

(57) ABSTRACT

A lens module includes a circuit board, a photosensitive chip, a filter, and a lens unit. The photosensitive chip is fixed on one surface of the circuit board. The filter faces the photosensitive chip. The lens unit includes a lens holder and a lens. The lens faces the filter. The lens holder is adhered to the circuit board and covers the photosensitive chip and the filter. The filter is fixed to an inner wall of a receiving hole defined in the lens holder.

### FIELD

The subject matter herein generally relates to lens modules, and more particularly to a lens module of an electronic device.

### BACKGROUND

Many electronic devices come equipped with lens modules for capturing images. With increasing demands for miniaturization of the electronic devices, the lens modules are desired to be smaller in size.

### BRIEF DESCRIPTION OF THE DRAWINGS

Implementations of the present disclosure will now be described, by way of embodiments, with reference to the attached figures.

FIG. 1 is an assembled, isometric view of an embodiment of a lens module.

FIG. 2 is an exploded, isometric view of the lens module in FIG. 1.

FIG. 3 is a cross-sectional view taken along line in FIG. 1.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

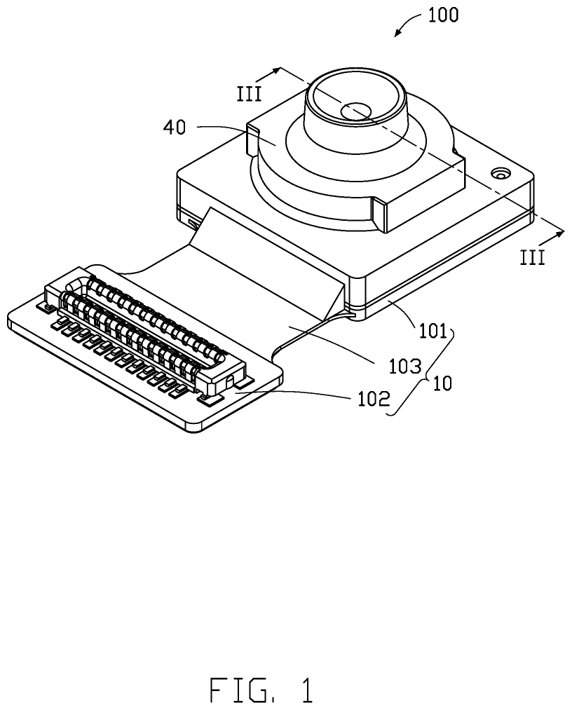

FIGS. 1-3 show an embodiment of a lens module 100. The lens module 100 may be applied in an electronic device (not shown), such as a smart phone or a tablet computer. The lens module 100 includes a circuit board 10, a photosensitive chip 20, a filter 30, and a lens unit 40.

The photosensitive chip 20 is fixed to one surface of the circuit board 10 through a first adhesive layer 21. In one embodiment, a size of the first adhesive layer 21 is equal to a size of the photosensitive chip 20. A material of the first adhesive layer 21 may be black glue or optical glue. The circuit board 10 may be a ceramic substrate, a soft board, a hard board, or a soft-hard composite board. In one embodiment, the circuit board 10 is a soft-hard composite board and includes a first hard portion 101, a second hard portion 102, and a soft portion 103 between the first hard portion 101 and the second hard portion 102. The photosensitive chip 20 is fixed on a surface of the first hard portion 101. A plurality of electronic components 11 and gold fingers 12 are mounted on the surface of the first hard portion 101 to which the photosensitive chip 20 is fixed. The electronic components 11 and the gold fingers 12 may be arranged around the photosensitive chip 20. A periphery of the photosensitive chip 20 is provided with a metal wire 22, and the metal wire 22 is electrically connected to the gold fingers 12. The photosensitive chip 20 may be a complementary metal-oxide semiconductor (CMOS) chip or a charge coupled device (CCD) chip. The metal wire 22 may be made of metal having a high electrical conductivity, such as gold. The electronic components 11 may be passive components such as resistors, capacitors, diodes, transistors, relays, electrically-erasable programmable read-only memories (EEPROM), or the like.

An electrical connection portion 13 is mounted on a surface of the second hard portion 102. The electrical connection portion 13 can be a connector or a gold finger.

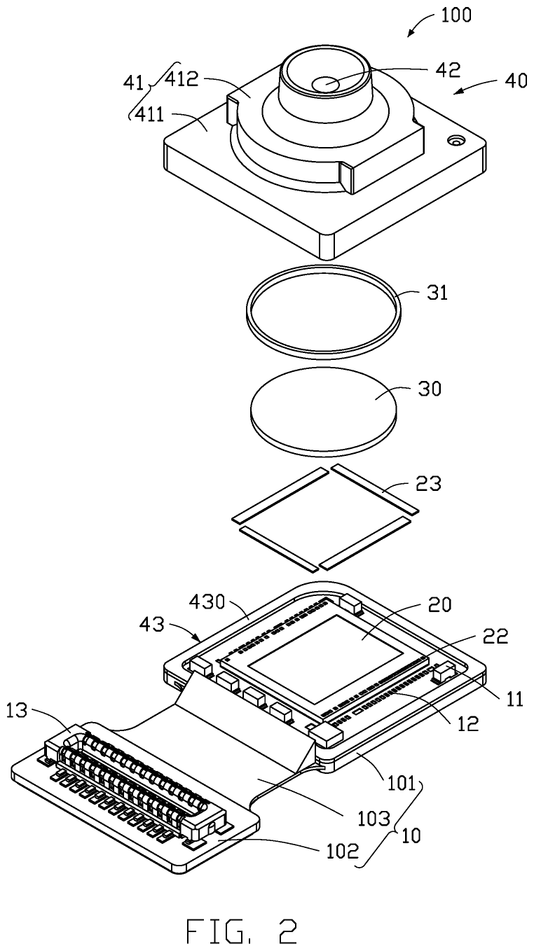

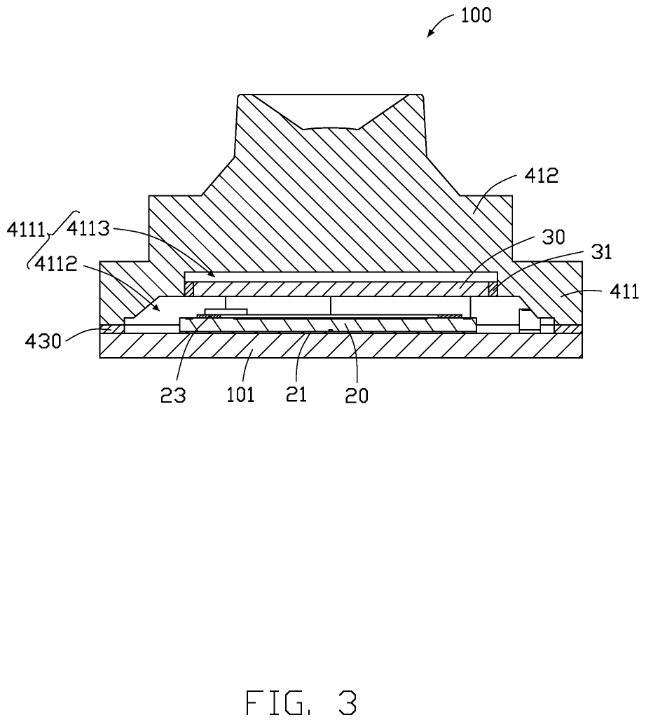

As shown in FIG. 2 and FIG. 3, in order to prevent image quality problems caused by dust falling on the photosensitive chip 20, a dustproof adhesive 23 is coated on a non-logic area of a surface periphery of the photosensitive chip 20. The dustproof adhesive 23 may be black glue or other optical glue.

The lens unit 40 is fixed to the circuit board 10 by a hollow adhesive layer 43.

The lens unit 40 includes a lens holder 41 and a lens 42 integrally formed in the lens holder 41. The lens 42 faces the photosensitive chip 20. In one embodiment, the lens holder 41 and the lens 42 are made of resin.

The lens holder 41 includes a substantially hollow rectangular first holding portion 411 and a substantially hollow second holding portion 412 connected to one side of the first holding portion 411. The lens 42 is molded in the second holding portion 412. A width of the first holding portion 411 is greater than a width of the second holding portion 412. The adhesive layer 43 is substantially rectangular and is formed by sequentially connecting four sides 430 end-to-end. The adhesive layer 43 may be made of optical glue. The first holding portion 411 is fixed to the circuit board 10 by the adhesive layer 43.

Referring to FIG. 3, the first holding portion 411 defines a receiving hole 4111 extending through the first holding portion 411. A width of the accommodating hole 4111 is larger than a width of the photosensitive chip 20, so that the photosensitive chip 20 is received in the accommodating hole 4111. In one embodiment, the electronic components 11 and the gold fingers 12 are also received in the receiving hole 4111.

The filter 30 is fixed in the receiving hole 4111 by a second adhesive layer 31. The filter 30 faces the photosensitive chip 20.

The receiving hole 4111 is a stepped hole and includes a first receiving portion 4112 adjacent to the circuit board 10 and a second receiving portion 4113 communicating with the first receiving portion 4112. A width of the first receiving portion 4112 is greater than a width of the second receiving portion 4113. The photosensitive chip 20 is received in the first receiving portion 4112. The filter 30 is fixed to an inner wall of the second receiving portion 4113 by the second adhesive layer 31.

The second adhesive layer 31 may be made of black glue or an optical glue. The filter 30 may be an infrared cut filter which is alternately plated with an optical film having a high refractive index on an optical substrate by a precision optical coating technique to realize a visible light region (400-630 nm) near-infrared (700-1100 nm) cut filter.

In use, the filter 30 filters out infrared rays from an optical signal projected through the lens 42 to a surface of the filter 30. The filtered optical signal projected to a surface of the photosensitive chip 20 is converted by the photosensitive chip 20 into an electrical signal. The photosensitive chip 20 outputs the electrical signal to the circuit board 10 through the metal wire 22, and the circuit board 10 processes the electrical signal. The lens module 100 can be connected to other components of the electronic device through the electrical connection portion 13.

Since the filter 30 is directly mounted in the lens holder 41, a mounting bracket in the related art for mounting the filter 30 is omitted, which is advantageous for reducing a size of the lens module 100. The filter 30 directly mounted in the lens holder 41 can prevent damage to the filter 30 and improve stability of the lens module 100. Furthermore, the dustproof adhesive 23 is coated on the non-logic area of the photosensitive chip 20 to prevent dust from entering the lens module 100 during a process of assembly, thereby improving a quality and reliability of the lens module 100.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

1. A lens module comprising:
a circuit board;
a photosensitive chip fixed on one surface of the circuit board;
a filter; and
a lens unit comprising a lens holder and a lens; wherein:
the lens holder comprises a rectangular first holding portion and a circular second holding portion connected to a side of the first holding portion, the first holding portion is disposed between the second holding portion and the circuit board, the first holding portion is adhered to the circuit board, the lens is mounted in the second holding portion, a width of the first holding portion is greater than a width of the second holding portion;
the first holding portion defines a receiving hole; and
the filter is fixed to an inner wall of the receiving hole.

2. (canceled)

3. The lens module of claim 1, wherein:
the lens holder is adhered to the circuit board by an adhesive layer.

4. The lens module of claim 1, wherein:
the receiving hole is a stepped hole comprising a first receiving portion and a second receiving portion;
the first receiving portion is adjacent to the circuit board, and the second receiving portion communicates with the first receiving portion;
a width of the first receiving portion is greater than a width of the second receiving portion;
the photosensitive chip is received within the first receiving portion;
the filter is fixed to the inner wall of the second receiving portion.

5. The lens module of claim 1, wherein:
the filter is fixed to the inner wall of the receiving hole by an adhesive layer.

6. The lens module of claim 1, wherein:
a dustproof adhesive is coated on a surface periphery of the photosensitive chip.

7. The lens module of claim 1, wherein:
the lens holder is integrally formed with the lens.

8. The lens module of claim 1, wherein:
the lens unit is made of resin.

9. The lens module of claim 1, wherein:
the filter is an infrared cut filter.

10. The lens module of claim 1, wherein:
the circuit board is a hard-soft composite board comprising a first hard portion, a second hard portion, and a soft portion;
the soft portion is located between the first hard portion and the second hard portion; and
the photosensitive chip is fixed to the first hard portion.

11. A lens module comprising:
a circuit board;
a photosensitive chip fixed on one surface of the circuit board;
a filter facing the photosensitive chip; and
a lens unit comprising a lens holder and a lens, the lens facing the filter; wherein:
the lens holder comprises a rectangular first holding portion and a circular second holding portion connected to a side of the first holding portion, the first holding portion is disposed between the second holding portion and the circuit board, the lens holder is adhered to the circuit board through the first holding portion and covers the photosensitive chip and the filter, the lens is mounted in the second holding portion, a width of the first holding portion is greater than a width of the second holding portion; and
the filter is fixed to an inner wall of a receiving hole defined in the first holding portion leas holder.

12. The lens module of claim 11, wherein:
the circuit board is a hard-soft composite board comprising a first hard portion, a second hard portion, and a soft portion;
the soft portion is located between the first hard portion and the second hard portion; and
the photosensitive chip is fixed to the first hard portion.

13. (canceled)

14. The lens module of claim 11, wherein:
the receiving hole is a stepped hole comprising a first receiving portion and a second receiving portion;
the first receiving portion is adjacent to the circuit board, and the second receiving portion communicates with the first receiving portion;
a width of the first receiving portion is greater than a width of the second receiving portion;
the photosensitive chip is received within the first receiving portion;
the filter is fixed to the inner wall of the second receiving portion.

15. The lens module of claim 14, wherein:
a dustproof adhesive is coated on a surface periphery of the photosensitive chip.

16. The lens module of claim 15, wherein:
a plurality of electronic components and gold fingers are mounted on the surface of the first hard portion to which the photosensitive chip is fixed;
the electronic components and the gold fingers are arranged around the photosensitive chip;
a periphery of the photosensitive chip is provided with a metal wire electrically connected to the gold fingers and the circuit board.
